(19) United States
(12) Patent Application Publication
(10) Pub. No.: US 2003/0190130 A1
(43) Pub. Date: Oct. 9, 2003

(54) Multiple optical pathway fiber optic cable

(75) Inventors: David J. Welker, Pullman, WA (US); Christopher D. Breckon, Pullman, WA (US); Christopher A. Richter, Pullman, WA (US); Todd E. Holt, Pullman, WA (US)

Correspondence Address: LEYDIG, VOIT & MAYER, LTD., (SEATTLE OFFICE), TWO PRUDENTIAL PLAZA, SUITE 4900, CHICAGO, IL, 60601-6780, US

(73) Assignee: Paradigm Optics, Inc., Pullman, WA

(21) Appl. No.: 10/387,708

(22) Filed: Mar. 12, 2003

Related U.S. Application Data
(60) Provisional application No. 60/370,174, filed on Apr. 5, 2002.

(51) Int. Cl. G02B 6/16

(52) U.S. Cl. 385/126; 385/114; 264/1.29

(57) ABSTRACT

A polymer fiber having multiple optical pathways set in a single cladding. The optical pathwaymultiple pathway fiber may be provided with connectors and thereby be used as a fiber cable for use with an interconnect. The optical pathwaymultiple pathway fiber may be constructed using a preform in a draw process. Alternatively, a novel vacuum draw method may be used in which optical pathway and cladding are mated and melded together during the draw process by creating a reduced pressure zone between the optical pathway and the cladding. A sacrificial substrate or cladding may be added around or along one side of the optical pathwaymultiple pathway fiber, and the combined cladding and fiber are drawn using a draw process. This cladding is removed, or partly removed, after the draw process. In this manner, the optical pathwaymultiple pathway fiber may have highly irregular and noncircular cross sections.

### REFERENCE TO RELATED APPLICATION

This application claims the benefit of the filing date of U.S. provisional application number 60/370,174, incorporated herein by reference.

### TECHNICAL FIELD OF THE INVENTION

This invention is related to data and image transmission lines, and more specifically to fiber optic cables.

### BACKGROUND OF THE INVENTION

Fiber optic cables provide an alternative to bulky copper wire cables in the telecommunications industry. A single fiber optic cable may carry several thousand data transmissions simultaneously, and may be as thin as a human hair.

In the typical construction of an optical fiber cable, a core having a high index of refraction is encapsulated in a cladding having a lower index of refraction. If light is emitted at one end of the core, it can travel through the core with very low loss, even if the fiber is curved. Light traveling inside the core strikes the surface of the core at an angle of incident greater than the critical angle so that the light is reflected toward the inside of the fiber (i.e., back into the core) without loss. Thus light can be transmitted over long distances by being reflected inward many times. In order to avoid losses through the scattering of light by impurities on the surface of the core, the optical fiber core is clad with a layer (e.g., cladding) having a lower refractive index. The reflections occur at the interface of the core and the cladding.

Over the past thirty years, and increasingly within the last decade, builders of long-distance fiber optic connections have worked at a furious pace to meet an expected increase in demand for bandwidth. In the meantime, the switching stations of the fiber communication networks in use today have been left behind, and are struggling to service the increase in data traffic from the original deployment of bandwidth offered by the networks' high-bandwidth fiber optic systems. The bandwidth mismatch has created what some have termed a ‘bottleneck.’ Such bottlenecks exist wherever a signal must change directions or “lanes” in the network. At each bottleneck, fast optical signals must be converted to electric signals, interpreted, routed in a new direction by slow copper connections, and then retransmitted as light signals on another path. Bottlenecks also occur in large computer systems that use electric copper connections to send data to and from different subsystems. Large computer systems are not limited by the speed of the processors or the memory but by the speed of the slow electric copper connections over which the signals must travel. To combat the problem, manufacturers and customers of super-high bandwidth digital machines have begun a race to replace older, all-electric devices with a new electro-optical technology that offers enormously increased performance at the bottleneck level.

This new electro-optic technology is the Vertical Cavity Surface Emitting Laser, or VCSEL. Compared to older lasers, VCSELs offer a drastic reduction in manufacturing and operating costs, operate at high data transmission rates, and can be made in high-density clusters on microchip wafers using methods similar to those used in the semiconductor industry. VCSELs offer both tremendous opportunity and challenge to those who use them to replace the larger, higher-cost lasers used in long distance networks or slower copper connections in network equipment. The opportunity lies in the many benefits over traditional lasers and all-electronic network devices. The challenge resides in finding an economic and scalable means of connecting VCSELs with optical fiber to external networks.

Presently, VCSELs are connected using parallel ribbons of single glass fibers. Connectorized glass fiber ribbons are fragile and expensive to manufacture. The fragility of glass fibers limits how much they can be bent into small packages. Glass fiber ribbon connections of just a few yards command a steep price causing VCSEL systems designers and customers to begin seeking an economical, scalable fiber optic cable alternative.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention provides a polymer fiber having multiple cores, or optical pathways, set in a single cladding. The polymer fiber may be used, for example, as a fiber cable for use with an interconnect. The polymer, multiple optical pathway fiber is easier to handle, manufacture, and package than the multiple, separate, individual fibers used in prior art cables for use with interconnects. In addition, because the present invention utilizes a flexible plastic, the multiple optical pathway fiber of the present invention is flexible and may be easily installed by a technician.

The number of optical pathways in the multiple optical pathway fiber is variable, and may range from two to hundreds. A large variety of different high temperature, chemically resistant and humidity resistant thermoplastics and/or resins may be used to manufacture the multiple optical pathway fiber. In addition, the cross section of the fiber is extremely variable, and may be, for example, a rectangle, a square, a circle, or any other suitable shape, including symmetrical or asymmetrical shapes. In addition, the configuration of each of the individual optical pathways is variable.

In accordance with one aspect of the present invention, the multiple optical pathway fiber may be provided with connectors so that it may be easily connected to a structure, such as a VCSEL array. The connectors preferably include a single, large opening that provides access to the optical pathways of the fiber. As such, the present invention provides a much easier and inexpensive way of connecting multiple optical channels than the prior art method of attaching multiple single glass fibers.

In accordance with another aspect of the present invention, the multiple optical pathway fiber is constructed using a preform in a draw process. However, if desired, the multiple optical pathway fiber may be produced by other methods, such as extrusion. In addition, a novel vacuum draw method may be used in which optical pathway(s) and cladding(s) are mated and melded together during the draw process by creating a reduced pressure zone between the optical pathway and the cladding. This novel vacuum draw method may also be used to form optical fibers having a single optical pathway (core).

In accordance with yet another aspect of the present invention, a sacrificial substrate or cladding may be added around or along one or more sides of the multiple optical pathway fiber preform, and the multiple optical pathway fiber preform and the sacrificial cladding are drawn using a draw process. If desired, the sacrificial cladding is removed after drawing of the fiber, for example by chemically dissolving the sacrificial cladding. In this manner, the multiple optical pathway fiber may have highly irregular and noncircular cross sections. The sacrificial cladding is removed after drawing of the fiber, for example by chemically dissolving the sacrificial cladding. The sacrificial cladding can also be left on the bulk of the fiber to serve as a protective layer or buffer.

Other advantages will become apparent from the following detailed description when taken in conjunction with the drawings, in which:

### BRIEF DESCRIPTION OF THE DRAWINGS

FIG. 1 is a diagrammatic isometric view of a multiple optical pathway fiber made in accordance with one aspect of the present invention;

FIG. 2 is an end view of the multiple optical pathway fiber of FIG. 1;

FIG. 3 is perspective view of a fiber preform for producing the multiple optical pathway fiber of FIG. 1;

FIG. 4 is an exploded perspective view of three pieces of a cladding preform for the fiber preform of FIG. 3;

FIG. 5 is an exploded end view of the three pieces of FIG. 4;

FIG. 6 is an exploded view of an annealing process for the fiber preform of FIG. 3;

FIG. 7 is an end view of the annealing process of FIG. 6;

FIG. 8 is a perspective view of a preform processing chamber for use in forming a fiber preform for the multiple optical pathway fiber of FIG. 1;

FIG. 9 is perspective view of the preform processing chamber of FIG. 8, showing polymeric material within the chamber;

FIG. 10 is an exploded perspective view showing removal of optical pathway rods from the preform processing chamber of FIG. 9;

FIG. 11 is an exploded perspective view showing insertion of optical pathway preforms into the preform processing chamber of FIG. 10;

FIG. 12 is an exploded perspective view showing removal of a fiber preform from the preform processing chamber of FIG. 11;

FIG. 13 is a diagrammatic view of a draw process that may be used to form the multiple optical pathway fiber of FIG. 1;

FIG. 14 is an perspective view of a fiber preform surrounded by a sacrificial cladding in accordance with one aspect of the present invention;

FIG. 15 is a cross section of the combined fiber preform and sacrificial cladding of FIG. 14;

FIG. 16 is an exploded end view of the combined fiber preform and sacrificial cladding of FIG. 14 in accordance with one aspect of the present invention;

FIG. 17 is a partial cutaway, perspective view of the fiber preform of FIG. 14 in a preform processing chamber;

FIG. 18 is a diagrammatic view of three different fiber preforms in sacrificial cladding and dipped into a solvent, with the sacrificial claddings dissolved different amounts;

FIG. 19 is a diagrammatic perspective view of a cladding and optical pathway that are melded together in a vacuum draw method in accordance with one aspect of the present invention;

FIG. 20 is a cutaway view of the cladding and optical pathway of FIG. 19;

FIG. 21 is an exploded perspective view of a cladding preform and optical pathway preforms that may be used in the vacuum process represented in FIG. 19;

FIG. 22 is a diagrammatic view of a the vacuum draw method represented in FIG. 19;

FIG. 23 is a partial cutaway exploded perspective view of the multiple optical pathway fiber of the present invention, with the fiber shown as being connected to a ferrule; and

FIG. 24 is an assembled perspective view of the multiple optical pathway fiber and ferrule of FIG. 23.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details. Furthermore, well-known features may be omitted or simplified in order not to obscure the present invention. In addition, to the extent that orientations of the invention are described, such as “top,” “bottom,” “front,” “rear,” and the like, the orientations are to aid the reader in understanding the invention, and are not meant to be limiting.

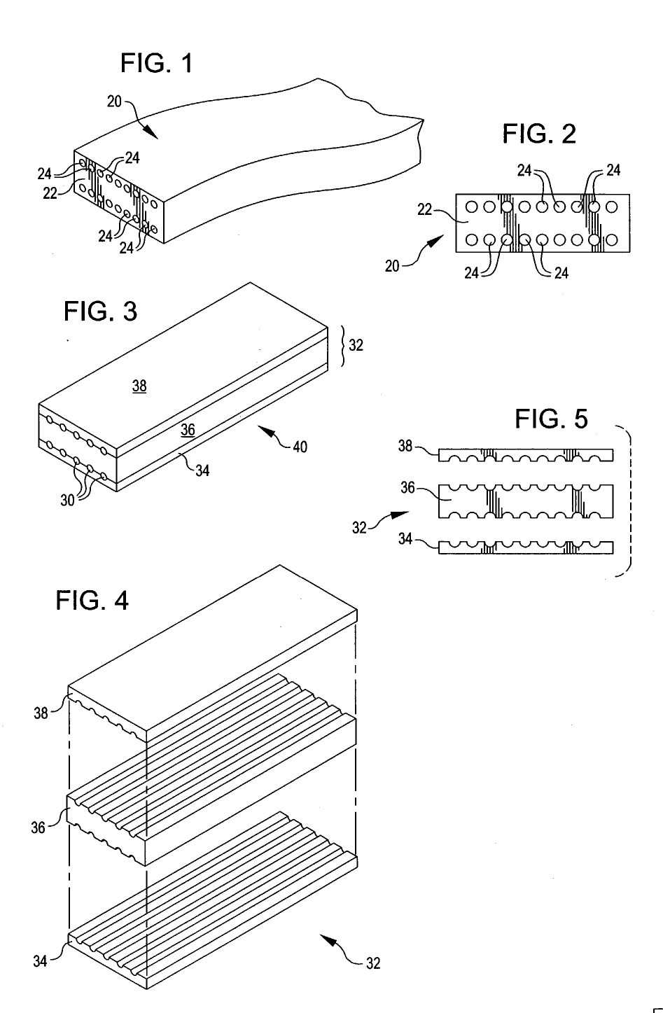

Turning now to the drawings, in which like reference numerals represent like parts throughout the several views, FIG. 1 shows a multiple optical pathway fiber 20 in accordance with one aspect of the present invention. The multiple optical pathway fiber 20 includes a plurality (i.e., more than one) of optical pathways 24 set in a cladding 22. An optical pathway may be defined as any optical conduit formed of one or more materials, and having various index of refraction profiles, including separate claddings. Optical pathways may have step-index, graded index, holey fiber or band-gap fiber configurations and may be configured for either multimode or single mode operation. In the embodiment shown in FIGS. 1 and 2, the number of optical pathways 24 in the cladding 22 is 18. That is, there are two rows of nine optical pathways 24 each. However, the number of optical pathways 24 in the multiple optical pathway fiber 20 of the present invention may be variable. As examples, the number of optical pathways 24 may be altered and arranged to match current commercial MT style ferrules, which are designed to mate 12 (1-by-12) or 24 (2-by-12) fibers. In other variations, 36 (i.e., 3-by-12) optical pathways 24 may be provided in a multiple optical pathway fiber 20, 48 (i.e., 4-by-12), 115 (i.e., 5-by-23), or any other combination may be presented. In addition, the arrangement and cross section of the multiple optical pathway fiber 20 may be varied. For example, although the embodiment shown in FIGS. 1 and 2 has a cross section of a rectangle, a multiple optical pathway fiber 20 may be provided that has a circular cross section, a square cross section, a triangular cross section, a hexagonal cross section, or a non-geometric or asymmetrical shape. A person of ordinary skill in the art may use the invention described herein to create any number of different shapes of multiple optical pathway fibers 20.

In accordance with one aspect of the present invention, both the optical pathways 24 and the cladding 22 are made of polymer materials, such as thermoplastics and/or resins. A number of different materials may be used, but preferably the optical pathways 24 and the cladding 22 are formed such that the optical pathways 24 have a higher refractive index than the cladding 22 so that optical transmission may occur through the optical pathways 24 in a manner known in the art. Examples of materials that may be used for the optical pathway 24 or cladding 22 include Ticona's Topas, a cyclic olefin copolymer, Solvay's Udel P-3703 NT 05, a polysulfone, poly(methyl(methacrylate)) (PMMA), polystyrene, Zeon's Zeonex, a polycarbonate, a polyurethane, as well as fluoropolymers that are presently available and used in the art.

There are a number of different methods that may be used to create the multiple optical pathway fiber 20. In accordance with one method of the present invention, as further described below, the multiple optical pathway fiber 20 may be formed by a draw process utilizing a fiber preform. The preform may be constructed in many ways. In general, however, the fiber preform includes optical pathway preforms and one or more clad preforms, and these structures are assembled and melded together to form the fiber preform. In accordance with one embodiment, an anneal method is used to create a preform for the multiple optical pathway fiber 20. Steps for this method are shown in FIGS. 3-7.

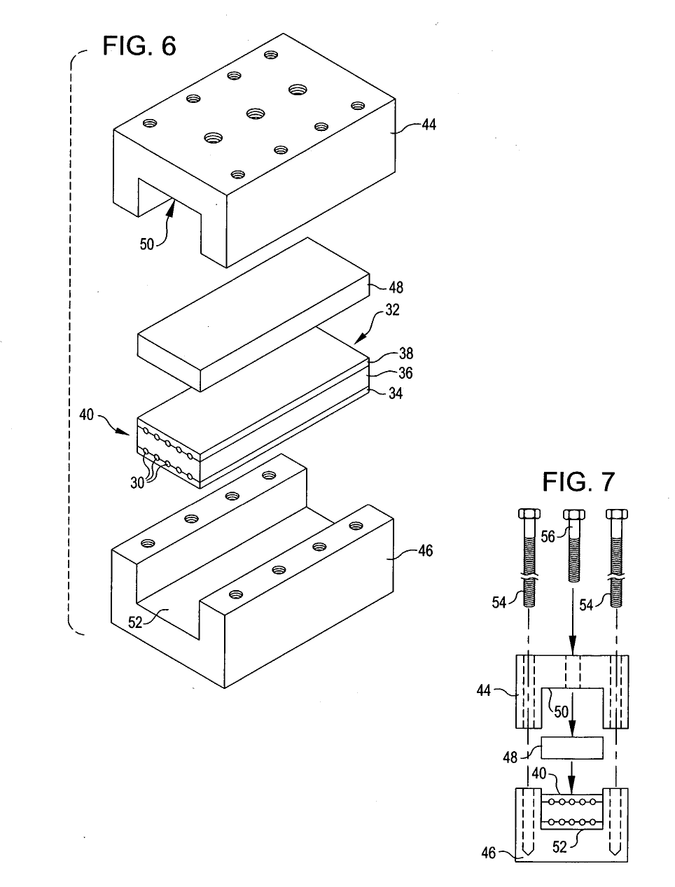

In accordance with the anneal method of the present invention, optical pathway preforms are prepared for the multiple optical pathway fiber preform by, as examples, drawing the optical pathway preforms from a larger piece of material, by extrusion, or by machining of optical pathway rods to the proper dimension from a larger piece of material. Example optical pathway preforms 30 are shown in FIGS. 3 and 6. The optical pathway preforms may be formed of several thermoplastics or resins, including those listed above for the cladding, to provide for various functions. In addition, the optical pathway preforms may take various configurations, depending upon the desired properties. These configurations may address, for example, a configuration for the optical pathway that provides a desired refractive index relative to the cladding. As examples, the optical pathway preforms may be made to have a stepped index or graded index configuration. They may also be designed to have single mode, photonic bandgap, or holey fiber configuration, all of which are known by those skilled in the art.

After formation, the optical pathway preforms 30 may be baked at an elevated temperature to reduce internal stresses and strains within the material. Preferably, this temperature is below the glass transition temperature of the polymer. More preferably, the temperature is 5 degrees below the glass transition temperature. The optical pathways are preferably baked for at least 24 hours, and more preferably a month, or a minimum amount of time determined not to degrade the optical/mechanical characteristics of the polymer/resin.

A cladding preform 32 in accordance with one embodiment of the invention is shown generally in FIGS. 3, 4, 5 and 6. The material for the cladding preform 32 may also be prepared by machining or extrusion, or by other suitable methods.

For the embodiment shown in FIGS. 3-6, the cladding preform 32 includes lower 34, middle 36, and upper 38 pieces. The facing surfaces of these pieces 34, 36, 38 include grooves therein for receiving the optical pathway preforms 30. The pieces 34, 36, 38 are shown separated from one another in FIGS. 4 and 5. Although a three piece cladding preform is shown, a person of skill in the art may utilize a many-tiered preform.

To assemble the preforms 30 and 32, the optical pathway preforms 30 are situated within the grooves on the faces of the cladding pieces 34, 36, 38, and the pieces are aligned together so as to sandwich the optical pathway preforms therein. The assembled structure, shown in FIG. 3, forms the fiber preform 40 for the multiple optical pathway fiber 20. In accordance with the annealing process of the present invention, this multiple optical pathway fiber preform 40 is annealed before use in a draw process. A structure that may be used for the annealing step is shown in FIGS. 6 and 7. In the embodiment shown, a squeezer top 44 fits over a squeezer bottom 46. A squeezer plate, or pressure plate 48, fits into a groove 50 in the bottom of the squeezer top 44. The multiple optical pathway fiber preform 40 fits into a corresponding groove 52 on the top surface of the squeezer bottom 46.

The squeezer top 44 and the squeezer bottom 46 are then attached together, for example by assembly bolts 54 (FIG. 7). Pressure is then applied to the pressure plate 48 to drive the multiple optical pathway fiber preform 40 into the groove 52. The pressure may be applied, for example, by one or more pressure bolts 56 that are threaded into the squeezer top 44 and that may be rotated to drive the pressure plate 48 downward against the multiple optical pathway fiber preform 40. The amount of pressure applied is preferably within the range of 5 to 30 kPa. If desired, a rail assembly and plugs (not shown, but known in the art) may be used to apply pressure to the ends of the multiple optical pathway fiber preform 40 while it is being squeezed.

While the pressure is being applied by the pressure plate 48, the multiple optical pathway fiber preform 40 may be annealed at an elevated temperature (e.g., in an oven). The annealing temperature is preferably above the glass transition temperatures for the optical pathway preform and the cladding preform, and more preferably is more than 5 degrees Celsius above, and no more than that temperature above which one of the polymers would be adversely mechanically or optically affected. The temperature increase also increases pressure, since the thermal expansion of most polymers is above that of the squeezer. The annealing cycle may be repeated several times at different temperatures to anneal the preform.

After annealing, the pressure is released and the multiple optical pathway fiber preform 40 is removed from the squeezer bottom 46. The multiple optical pathway fiber perform 40 is ready for being drawn to form the multiple optical pathway fiber 20, as described further below.

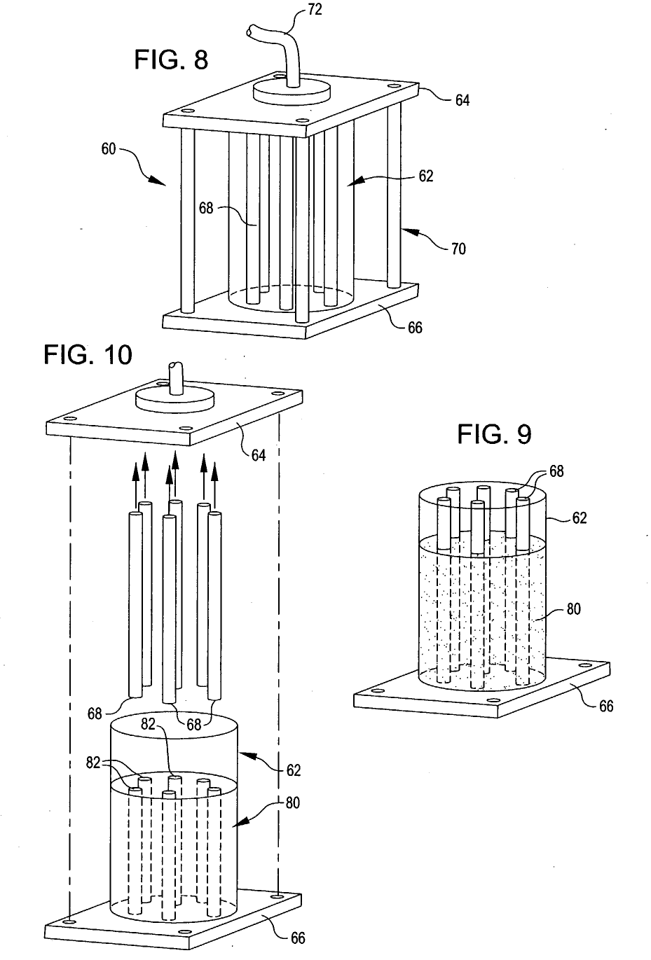

In accordance with another aspect of the present invention, preforms for the multiple optical pathway fiber 20 may be formed in a preform production chamber such as a preform production chamber 60 shown in FIG. 8. The preform production chamber 60 shown in the drawings includes a hollow cylinder 62 between a top plate 64 and a bottom plate 66. Each of these members preferably includes internal surfaces that easily release from a polymeric material. For example, the top plate 64 and the bottom plate 66 may be formed of Teflon. The hollow cylinder 62 may be formed of glass, steel, Teflon, or any other suitable material. However, by forming it of glass, the interior of the preform production chamber 60 may be seen. In one embodiment, a series of optical pathway rods 68 extend from the top plate 64 to the bottom plate 66 and inside the hollow cylinder 62. The optical pathway rods 68 may, for example, fit into indentations in the bottom plate 66 and the top plate 64. Alternatively, the optical pathway rods 68 may be attached to the top plate 64 or may otherwise be suitably arranged in the hollow cylinder 62.

Pressure rods 70 extend from the corners of the top plate 64 to the corners of the bottom plate 66. A vacuum attachment or hose 72 is provided on the top plate 64, and is in fluid communication with the interior of the preform production chamber 60.

In use, the preform production chamber 60 may be prepared with a mold release agent such as is known in the art. The mold release agent is applied to the inner surfaces of the preform production chamber 60 and to the optical pathway rods.

After the mold release agent is applied, the preform production chamber 60 is filled with the polymeric material that is used to form the cladding preform for the multiple optical pathway fiber preform. The polymeric material may be applied in at least two different states: as a plastic monomer liquid, or as solid plastic pellets or other small form pieces of plastic that are solid. The different methods for handling the liquid and solid polymeric materials are addressed in the following paragraphs.

Plastic monomer may be poured straight from a bottle, or, more preferably, is vacuum distilled to remove impurities, and inhibitor (if present) is removed. A polymerization additive, such as a chain transfer agent, may be added, for example at 0.33% by volume. In addition, a polymerization additive, such as an initiator, may be added, for example less than one percent by volume, or more preferably 0.33% by volume.

If a plastic monomer liquid is used, then the top plate 64 is sealed over the hollow cylinder 62, and the plastic monomer liquid is polymerized in the preform production chamber 60 under vacuum (i.e., with vacuum being applied to the vacuum connection 72). Vacuum may be applied at below atmospheric pressure, preferably better than 29 inches Hg. Polymerization for PMMA may occur over a broad range of temperatures, for example, at less than 0 to over 100 degrees Celsius, but more preferably at 70 +/−10 degrees Celsius. The polymeric material polymerizes around the optical pathway rod 68 and within the hollow cylinder 62. If desired, finishing steps can be employed to finish polymerization and rid the polymer of excess initiator, a step well known by those skilled in the art.

If solid plastic pellets or other small solid pieces are used, then the solid material is melted in the preform production chamber 60 under vacuum (similar vacuum pressures to those discussed above may be used). The solid plastic may be washed prior to use, for example with distilled water. If washed, the solid plastic is preferably washed in a dust-free environment, (class 10,000 or better), and is baked above 100 degrees Celsius for at least 4 hours to remove all water.

When melting, the plasticized material forms around the optical pathway rods 68 and inside the hollow cylinder 62. The polymeric material, which eventually becomes the cladding preform for the fiber preform, is shown in the preform production chamber 60 in FIG. 9 generally by the reference numeral 80.

Regardless of the state of the polymer material used, after the polymeric material has been polymerized or melted into the form of the interior of the preform production chamber 60, the top plate 64 is removed, such as is shown in FIG. 10. The optical pathway rods 68 are then pulled out of the cladding preform 80. To this end, the optical pathway rods include a nonstick surface, such as Teflon, which permits removal of the optical pathway rods 68 from the polymerized cladding preform 80. Removal of the optical pathway rods 68 leaves a series of elongate holes or voids 82 through the cladding preform 80.

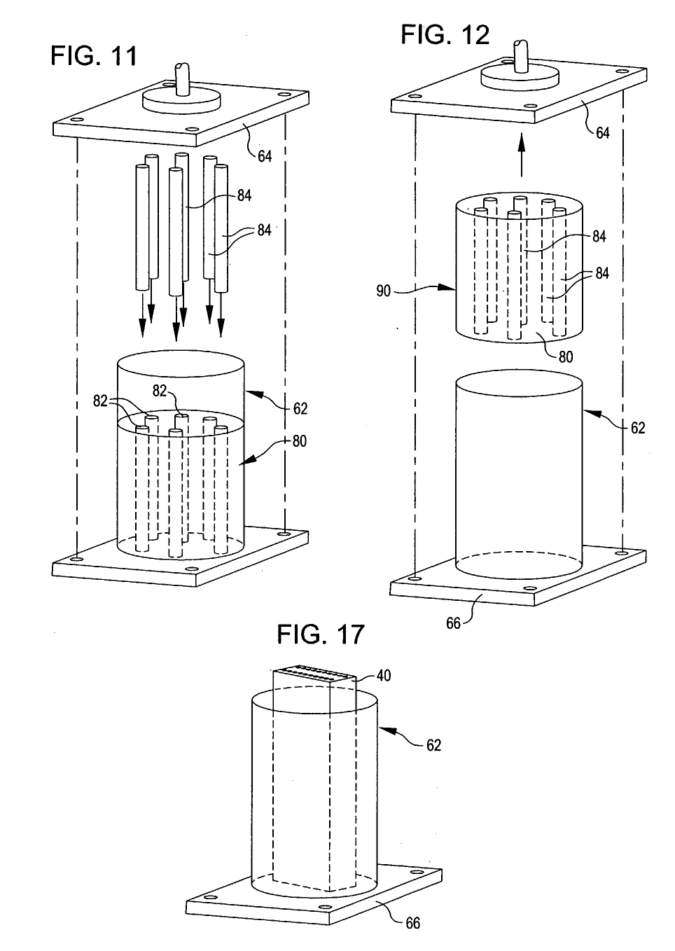

As can be seen in FIG. 11, optical pathway preforms 84, such as the optical pathway preforms 30 discussed earlier, are then inserted into the holes or voids 82 in the cladding preform 80. Preferably, the optical pathway preforms 84 fit snugly into the voids or holes 82, so that no voids or air gaps are formed in the final multiple optical pathway fiber preform 40.

The top plate 46 is then replaced, vacuum is applied, and the combined optical pathway preforms 84 and the cladding preform 80 are heated. In this manner, the optical pathway preforms 84 and the cladding preform 80 meld together. After polymerization, the combined cladding preform and optical pathway preforms are removed from the hollow cylinder 62, as shown in FIG. 12. The removed, combined, cladding preform 80 and optical pathway preforms 84 form the multiple optical pathway fiber preform 90, similar to the multiple optical pathway fiber preform 40 discussed above.

In accordance with another aspect of the present invention, preforms for the cladding material of the multiple optical pathway fiber 20 may be formed in a preform production chamber (e.g., the preform production chamber 60 shown in FIG. 8) around optical pathway preforms. After a mold release agent is applied, optical pathway preforms (with or without cladding) are inserted into the preform production chamber 60, which is then filled with the polymeric material that is used to form the bulk of the cladding preform for the multiple optical pathway fiber preform. The polymeric material for the cladding preform may, for example, be applied as a plastic monomer liquid or solids, as described above. The cladding preform material is then polymerized around the optical pathway preforms, and the two are polymerized together as described above so that they meld together.

The multiple optical pathway fiber preform 40 or 90 (for ease of reference, the reference numeral 40 will be used hereinafter, but it is to be understood that either type of method, or other methods, may be used to form the multiple optical pathway fiber preform) may be machined if desired so as to form a particular shape. Alternatively, the multiple optical pathway fiber preform 40 may be used as formed in the annealing or preform production chamber process. The multiple optical pathway fiber preform 40 is then ready for a draw process to form the multiple optical pathway fiber 20.

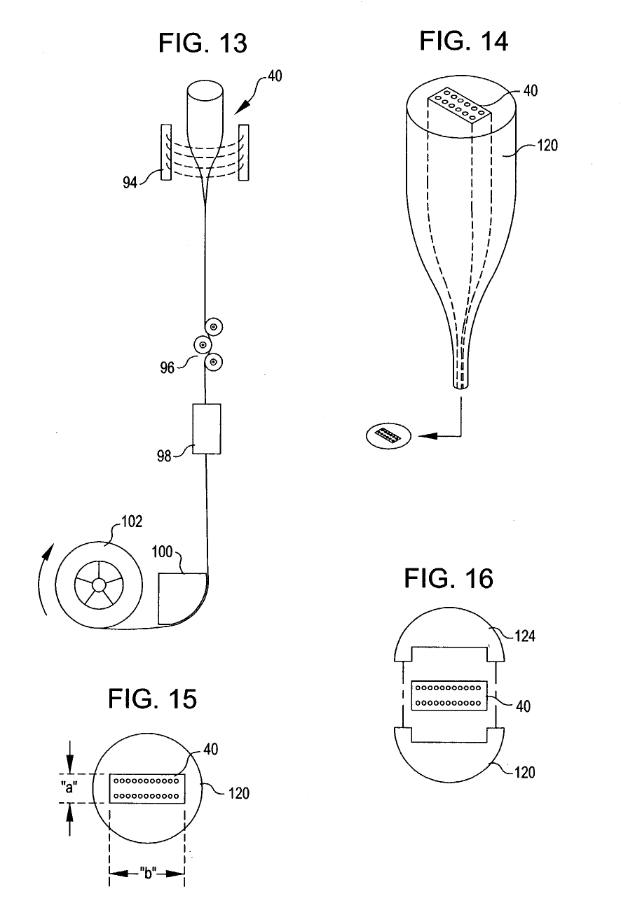

A draw process for creating the multiple optical pathway fiber 20 is shown schematically in FIG. 13. The draw process shown there is known in the art, and differs only in that the multiple optical pathway fiber preform 40 (not known in the art) is used in the draw process. Although draw processes are well known in the art, a brief description is given here for the aid of the reader.

In the draw process of FIG. 13, the multiple optical pathway fiber preform 40 is located between and in a radiative heat oven 94. The heat oven 94 heats the multiple optical pathway fiber preform 40 so that it is flowable, and flowable plastic from the bottom of the multiple optical pathway fiber preform 40 is drawn through a tension gauge 96 and a diameter guide 98 around a turn guide 100 and onto a take-up spool 102. The take-up spool 102 rotates at a rate that is sufficient to draw fiber (in this case, the multiple optical pathway fiber 20) at a rate from the multiple optical pathway fiber preform 40 so that the fiber is a substantially constant diameter. The diameter gauge 98 passively checks the diameter of the fiber that is being drawn. To allow proper drawing of the fiber preform 40, the optical pathway material of the preform and the cladding material of the preform preferably must have melting temperatures that are substantially the same so that they may be drawn at a single temperature. More specifically, the melting temperatures of the optical pathway material and the cladding material should be within 150 degrees Celsius of one another. Alternately, any combination of polymers chosen for use in manufacturing the fiber should have an approximately equivalent electromagnetic radiation cross section for a given range of wavelengths as emitted by the heat source used in the draw process.

The draw process of FIG. 13 works well for many preforms, but applicants have found that fibers with odd cross sections distort when they are drawn using that process. For example, when a long or wide rectangular cross section fiber is drawn, the fiber cross section often looks like a bow tie, i.e., wide on the ends and narrow in the middle. However, when fibers are drawn that have a fairly symmetrical shape and aspect ratio, they tend to maintain their cross sections when they are drawn. More specifically, applicants have found that fiber designs with an aspect ratio of a/b being less than approximately 4 tend to maintain their cross sections when drawn. In this formula, a and b are the x and y dimensional measurements, respectively, of a cross section of the preform. Thus, when hexagons, circles, or square are drawn, the fiber tends to maintain its shape.

However, when the aspect ratio of a/b is greater than or equal to approximately 4, then the fiber tends to distort. Moreover, when the cross section is not symmetrical, e.g., include a protrusion on one side or a circular side opposite a squared off side, then the fiber is often distorted upon drawing. To address this fiber distortion, the present invention provides a sacrificial cladding material that is applied on the outside of a fiber preform, e.g., the multiple optical pathway fiber preform 40. In general, the sacrificial cladding is added to the fiber preform so that the two combined materials have a cross section (e.g., a circle) that does not distort upon drawing. If desired, the sacrificial cladding material is then removed. In this process, because the combined structure does not distort, the fiber preform does not distort upon drawing. Thus, the sacrificial cladding permits fibers to be drawn having various cross-sectional configurations. Sacrificial cladding may be used to draw fibers having highly irregular and asymmetrical cross sections, whether the fibers include a single optical pathway or multiple optical pathways (e.g., the multiple optical pathway fiber 20).

A sacrificial cladding is shown generally at 120 in FIG. 14. The sacrificial cladding, together with the fiber preform, form a cross section with an aspect ratio that is substantially equal to 1, and that is symmetrical. For best results, the cross section is a circle, although other shapes may be used. In this manner, the resulting drawn fiber (which includes the sacrificial cladding) does not distort and the fiber preform maintains its shape upon drawing. A cross section of the sacrificial cladding 120 and the fiber preform 40 is shown in FIG. 15.

The sacrificial cladding may be formed about the fiber preform 40 using an annealing method such as is described above, and which the parts of one embodiment of which are shown in FIG. 16. In FIG. 16, the fiber preform 40 is sandwiched between two sacrificial cladding halves 122, 124. The fiber preform 40 and the sacrificial cladding halves 122, 124 are joined such as described with the annealing process above.

As an alternative, the sacrificial cladding 120 may be added in a melting or polymerization sequence, such as is described with reference to the preform production chamber 60 above. An example is shown in FIG. 17, where a fiber preform 40 is placed in the hollow cylinder 62. The polymeric material may then be added around the fiber preform 40 and melted or formed with the fiber preform 40.

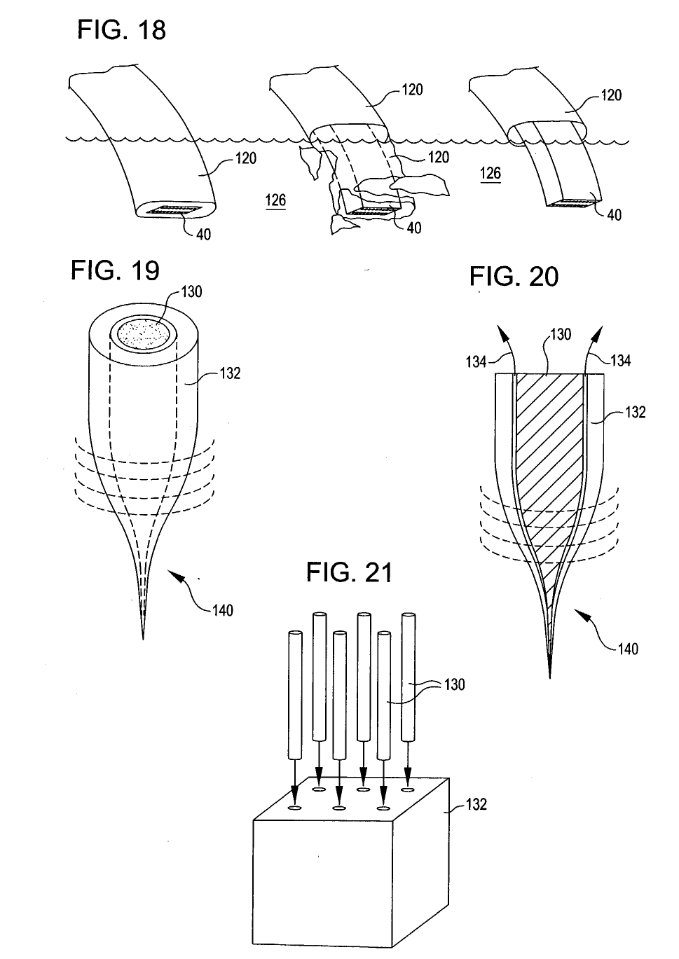

After the sacrificial cladding 120 is added to the fiber preform 40, the unwanted cladding is removed by chemical etching. Chemical etching attacks or dissolves away the sacrificial cladding 120. This process is shown in FIG. 18, where, from left to right, a fiber preform 40 and sacrificial cladding 120 are inserted into and maintained within a solvent 126. The sacrificial cladding 120 and the fiber preform 40 have just entered the solvent on the left, have been held in the solvent an intermediate amount in the middle, and have been held long enough on the right so that the sacrificial cladding 120 has dissolved away.

Naturally, if etching is used, materials for the fiber preform 40 and the sacrificial cladding 120 must be chosen so that the sacrificial cladding 120 dissolves and the inner fiber is not susceptible to the solvent. In addition, regardless of what operation is used to remove the sacrificial cladding 120, the sacrificial cladding 120 preferably has a melting temperature that is substantially the same, as described above, as the fiber preform 40 so that the two may be drawn at a single temperature. As an example, the sacrificial cladding 120 may be formed of poly(methyl(methacrylate)) (PMMA), and may be dissolved in acetone.

If desired, the combined sacrificial cladding 120 and the fiber may be held in the solvent 126 at a length that is less than needed to dissolve away all the sacrificial cladding 120. As such, only a portion of the sacrificial cladding 120 is removed, such as is shown in the far right position of FIG. 18. The sacrificial cladding 120 left on or around the inner fiber may function as a protective jacket or layer for the fiber.

Other methods may be used to remove the sacrificial cladding, such as melting the cladding away, or mechanically removing the cladding. However, the chemical etching of the described embodiment has been found to work rather well, and does not harm or distort the drawn fiber (e.g., a multiple optical pathway fiber 20).

FIGS. 19-22 show a novel drawing method in accordance with one aspect of the present invention. Generally described, the drawing method shown in FIGS. 19-22 permits optical pathway and cladding materials of optical fiber to be mated and melded together during the draw process by creating a reduced-pressure zone between the two materials. This method may be used to create the novel multiple optical pathway fiber 20 of the present invention, or may be used for a fiber having a single optical pathway.

As part of the novel draw method, vacuum is applied to the top of the optical pathway and the cladding as the two materials are being inserted together into the radiative heating zone of a draw process. The optical pathway 130 inserted into the cladding 132 is shown in FIG. 19. As can be seen in FIG. 20, the application of vacuum causes air to be pulled out of the interface between the optical pathway 130 and the cladding 132, as is shown by the arrows 134. In accordance with the process of this aspect of the invention, the optical pathway 130 is inserted into the cladding 132, vacuum is applied, and the two are fed into the heating zone 140 for the drawing process.

Similarly, the process of this aspect of the present invention may be used for a cladding that includes multiple optical pathways, such as is shown in FIG. 21. Again, the optical pathway preforms are inserted into the cladding preforms and vacuum is applied to the top of the combined preforms as the preform structure enters the heating zone of the draw process.

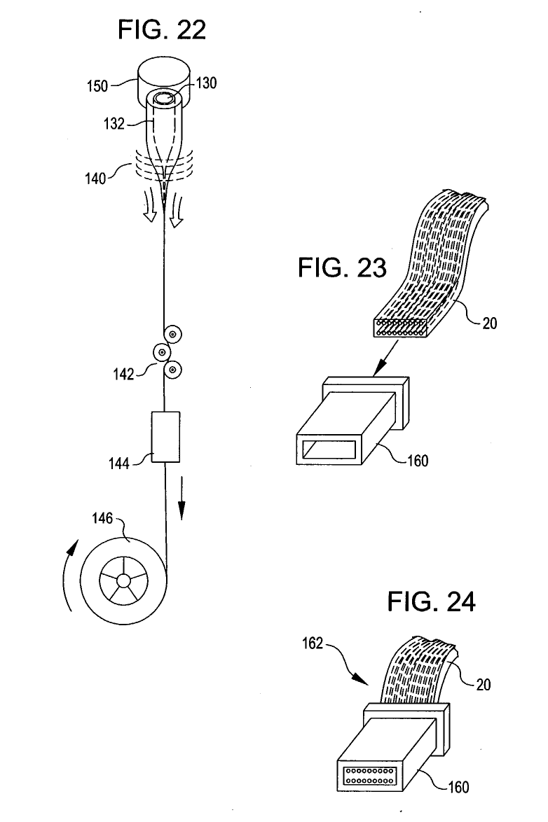

A draw process utilizing the vacuum is shown schematically in FIG. 22. In that figure, a tension gauge 142, a diameter gauge 144 and a take-up reel 146 are used similar to those described with FIG. 13. However, unlike the draw process in FIG. 13, the draw process in FIG. 22 does not include a optical pathway and cladding that have been mated or melded together prior to the draw process. That is, a fiber preform is not used in the drawing process. Instead, as described above, the optical pathway is simply inserted into the cladding. A vacuum attachment device 150 is clamped around the top of the optical pathway and the cladding. The vacuum device 150 and the combined optical pathway 130 and cladding 132 are then lowered into the heating zone 140. Vacuum is applied by the vacuum device, for example at the pressure described above. When the optical pathway and cladding reach the heating zone, the optical pathway and cladding are melded together. The melding process is controlled because the vacuum is applied, permitting no air to be present between the interface of the optical pathway 130 and the cladding 132. The vacuum draws the two materials together, and avoids air pockets. Again, as described above, this drawing method utilizing vacuum could be used on a multiple optical pathway fiber. In addition, the drawing and vacuum method may be used not only to meld a optical pathway and cladding, but also to meld a sacrificial cladding to the outside of the fiber preform during drawing.

After the multiple optical pathway fiber 20 has been formed (e.g., by any of the draw processes described above), it may be terminated using a connector or connectors, such as a ferrule 160, such as is shown in FIG. 23. The ferrule 160 is of the type that is known in the art.

The connection of the multiple optical pathway fiber 20 does not require the connection of multiple individual fibers to the ferrule, instead only requires the connection of the single multiple optical pathway fiber 20. The multiple optical pathway fiber 20 may be simply attached to the ferrule 160 by inserting the end of the multiple optical pathway fiber into the ferrule and attaching with an adhesive. The inside of the opening on the front of the ferrule provides access to a plurality of optical pathways. The optical pathways may be aligned such that they mate with industry 1×12 or 2×12 MT ferrules. The combined multiple optical pathway fiber 20 and ferrule 160, shown generally as 162 in FIG. 24, may be used as a high density optical cable with an interconnect.

The high density optical cable 162 of the present invention is easier and less expensive to fabricate than standard MT connectors. It is far easier and less expensive to insert one large multiple optical pathway fiber into a ferrule than to insert 12, 24 or more small fibers into individual holes on existing MT connectors. Also, it is far easier to produce an optical finish on a polymer fiber filled MT ferrule than on standard MT ferrules.

The present invention of the multiple optical pathway fiber 20 includes additional benefits. Not only are the cables for use with interconnects formed by the multiple optical pathway fiber 20 dramatically less expensive, they also have additional benefits such as being formed by a polymer which is more flexible than glass, which permits a system designer to incorporate tighter bends and twists in the system. Also, polymer multiple optical pathway fibers 20 may be manufactured with higher densities of optical pathways than can be accomplished with individual glass fibers, which allows for smaller overall package design.

Manufacturing of the multiple optical pathway fibers is also less expensive. A multiple optical pathway fiber 20 saves cost because the ferrules are less expensive (i.e., include one slot instead of multiple holes), the number of ferrules needed decreases (i.e., one slotted ferrule as opposed to two or more standard MT ferrules may be used), labor is decreased for inserting fibers into ferrules, polishing time for ferrules is reduced, and fiber cost is reduced, because a single multiple optical pathway fiber is less expensive to fabricate than 12 or more individual glass fibers.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention.

What is claimed is:

1. An optical fiber, comprising:
a polymer or resin cladding; and
a plurality of polymer or resin optical pathways in the cladding.

2. The optical fiber of claim 1, further comprising a ferrule attached to an end of the optical fiber.

3. The optical fiber of claim 2, further comprising a second ferrule attached to an opposite end of the optical fiber.

4. The optical fiber of claim 1, wherein the polymer or resin cladding comprises at least one material from the subset of a cyclic olefin copolymer, cyclic olefin polymer, a polysulfone, poly(methyl(methacrylate)) (PMMA), polystyrene, polycarbonate, a polyurethane, and a fluoropolymer.

5. The optical fiber of claim 1, wherein the plurality of polymer or resin optical pathways comprise at least one material from the subset of a cyclic olefin copolymer, cyclic olefin polymer, a polysulfone, poly(methyl(methacrylate)) (PMMA), polystyrene, polycarbonate, a polyurethane, and a fluoropolymer.

6. The optical fiber of claim 1, wherein the plurality of polymer or resin optical pathway to have a stepped index or graded index profile configuration.

7. The optical fiber of claim 1, wherein the plurality of polymer or resin optical pathways to have a single mode, multimode, photonic bandgap, or holey fiber index profile configuration.

8. The optical fiber of claim 1, wherein the melting temperatures of the optical pathway material and the cladding material are within approximately 150 degrees Celsius of one another.

9. An optical fiber interconnect, comprising:
an optical fiber, comprising:
a polymer or resin cladding; and
a plurality of polymer or resin optical pathways in the cladding; and
a ferrule attached to an end of the optical fiber.

10. The optical fiber interconnect of claim 9, further comprising a second ferrule attached to an opposite end of the optical fiber.

11. A method of forming an optical fiber, comprising:
forming a fiber preform comprising:
a polymer or resin cladding; and
a plurality of polymer or resin optical pathways in the cladding; and
drawing the preform so as to form an optical fiber.

12. The method of claim 11, wherein forming the fiber preform comprises annealing the polymer or resin cladding and plurality of polymer or resin optical pathways together prior to drawing the preform.

13. The method of claim 11, wherein forming the fiber preform comprises annealing the polymer or resin cladding and plurality of polymer or resin optical pathways while drawing the preform.

14. The method of claim 11, further comprising, prior to forming the fiber preform, forming the cladding preform in an annealing process and utilizing multiple polymer or resin pieces.

15. The method of claim 11, further comprising, prior to forming the fiber preform, forming the cladding preform in a chamber having an interior shaped to match an exterior of the cladding preform.

16. The method of claim 15, wherein the chamber comprises a plurality of rods for shaping holes in the cladding preform for the plurality of optical pathways.

17. The method of claim 16, further comprising removing the plurality of rods after forming the cladding preform, and inserting the plurality of optical pathways into the holes to form the fiber preform.

18. The method of claim 11, further comprising machining the optical fiber after drawing.

19. The method of claim 11, further comprising annealing the fiber preform prior to drawing.

20. The method of claim 11, wherein a cross section of the fiber preform comprises an aspect ratio less than or equal to approximately 4 to 1.

21. The method of claim 11, further comprising adding a sacrificial cladding around at least a part of the fiber preform prior to drawing.

22. The method of claim 21, wherein a cross section of the fiber preform comprises an aspect ratio greater than 4 to 1, and wherein the aspect ratio of the combination of the sacrificial cladding and the fiber preform is less than or equal to approximately 4 to 1.

23. The method of claim 22, wherein the aspect ratio of the a combination of the sacrificial cladding and the fiber preform is approximately equal to 1.

24. The method of claim 21, wherein the wherein the melting temperatures of the fiber preform and the sacrificial cladding are within approximately 150 degrees Celsius of one another.

25. The method of claim 21, wherein the sacrificial cladding is added to the fiber preform by annealing.

26. The method of claim 21, wherein the sacrificial cladding is added to the fiber preform by melting or polymerization.

27. The method of claim 21, further comprising removing at least a portion of the sacrificial cladding after drawing.

28. The method of claim 27, wherein the portion is removed by etching.

29. The method of claim 27, wherein the portion is removed by melting.

30. The method of claim 27, wherein the portion is removed by mechanical removal.

31. The method of claim 27, wherein the portion comprises substantially all of the sacrificial cladding.

32. The method of claim 11, further comprising attaching at least one ferrule to an end of the optical fiber.

33. A method of forming an optical fiber, comprising:
inserting a polymer or resin optical pathway into a polymer or resin cladding so as to form a fiber preform;
applying vacuum to the polymer or resin optical pathway and the polymer or resin cladding so as to remove air between the two;
applying heat and drawing the fiber preform, the heat being sufficient to meld the polymer or resin optical pathway to the polymer or resin cladding and to allow drawing of the fiber preform; and
drawing the fiber preform.

34. The method of claim 33, wherein the fiber preform includes a sacrificial cladding about at least a part of its outer surface, and wherein the vacuum is also applied to the sacrificial cladding and applying heat causes the sacrificial cladding to meld to the fiber preform.

35. A method of forming an optical fiber, comprising:
inserting a plurality of polymer or resin optical pathways into a polymer or resin cladding so as to form a fiber preform;
applying vacuum to the plurality of polymer or resin optical pathways and the polymer or resin cladding so as to remove air between the plurality of polymer or resin optical pathways and the polymer or resin cladding;
applying heat to meld the plurality of polymer or resin optical pathways to the polymer or resin cladding; and
drawing the fiber preform.

36. The method of claim 35, wherein the heat is sufficient to meld the plurality of polymer or resin optical pathways to the polymer or resin cladding and allow drawing of the fiber preform.

37. The method of claim 35, wherein the fiber preform includes a sacrificial cladding about at least a part of its outer surface, and wherein the vacuum is also applied to the sacrificial cladding and applying heat causes the sacrificial cladding to meld to the fiber preform.
